(19) United States
(12) Patent Application Publication
(10) Pub. No.: US 2014/0041280 A1
(43) Pub. Date: Feb. 13, 2014

(54) BUOYANT FISHING DEVICE

(71) Applicant: Craig ERISMAN, Lee's Summit, MO (US)

(72) Inventor: Craig ERISMAN, Lee's Summit, MO (US)

(21) Appl. No.: 13/571,846

(22) Filed: Aug. 10, 2012

(51) Int. Cl. A01K 97/12; A01K 93/00; A01K 97/00

(52) U.S. Cl. 43/17; 43/17.5; 43/43.1

(57) ABSTRACT

A buoyant fishing device comprising a substantially hollow container body, a rigging ring operably connected to the body, and an illumination device disposed within said body. The body may include a neck portion. The rigging ring includes a band having a first end and a second end defining a length wherein the band is configured to extend around the container circumferentially and in one embodiment, a securing mechanism is used to fix first end with respect to second end. In another embodiment rigging ring is welded or fused together during manufacture. The illumination device illuminates the body of the buoyant fishing device and may be a glow stick or a light in electronic communication with a battery.

### CROSS-REFERENCE TO RELATED APPLICATION

None.

### BACKGROUND OF THE INVENTION

This present invention relates to a device to assist a recreational fisherman while fishing. Fishing is a very popular hobby for many individuals and there are hundreds of sport fish throughout the world. Each fish has its own peculiar behavior patterns. Fishermen attempt to use the particular behavior patterns of a particular fish to assist in locating where that fish will be, appeal to the fish's eating habits, and pick the right time of the day when those fish are most active and, thus, easiest to catch. This behavioral study, observation and pattern recognition results in certain environmental conditions that fishermen attempt to replicate or take advantage of when trying to catch a particular type of fish.

One popular fish is catfish. Catfish are popular because they can grow to be very large, and as such, are fun to catch, fight and land. Catfish are generally nocturnal and, therefore, the most ideal time to fish for them is at night. Further, most catfish species are bottom feeders that generally feed through suction or gulping rather than biting. Other behavior patterns of catfish include catfish like to reside and position themselves in naturally-formed caves, holes, voids, or other protected structures underwater when not out swimming and looking for food. In man-made reservoirs, catfish often reside and position themselves between voids within the piled up rip-rap concrete or other material used to stabilize the shoreline or dam.

There are many methods fisherman employ to catch catfish. Some of the most popular methods include: jug-fishing, traditional bait-cast fishing, noodling, drifting, limb-lining, and trot-lining. Bait-cast fishing for catfish is also a very popular fishing technique wherein a fisherman uses a rod and reel to cast bait and/or lures out into the water from the shore or a boat. The fisherman may actively continue to reel in and re-cast the bait and/or lure, or he or she may let the bait sit to attract a fish. When catfishing, a common method is to place odorous bait in the water for an extended period of time with the hope of attracting a catfish. Common baits used in catfishing are bait-fish like shad or minnows, or other bait like chicken livers, night crawlers, stink-bait, artificial lures, or any combination thereof. When fishing in a body of water that has a rocky or jagged bottom or shore, traditional bait-casting has a few shortcomings. First, in the event a fisherman catches a catfish, particularly a larger catfish, reels that hold the extra line are set with a drag which allows the line to be taken out under a certain amount of force. Thus, once a bigger fish realizes it is hooked, it often attempts to run to a safe location, such as a cave, void, recess in the rock or in the concrete rip-rap shore. If the fish makes it to the shore and/or its cave, then the rough, rocky formations of the shore often cut or nick the line while the fish is fighting, and this causes the line to break under tension thereby losing and releasing the fish before it is landed. A line breaking while attempting to land any fish continually frustrates fishermen.

Moreover, because catfish are nocturnal, fishermen using a traditional bait casting rig have a hard time seeing where the line is and, if using a strike indicator or bobber, seeing the bobber move when the catfish inhales the bait. Thus, a fisherman may not even know that he or she has caught a fish while fishing at night.

Jug-fishing is another technique that can be an effective method for catching a large number of fish. When jug fishing, a fisherman will place numerous jug rigs in the water providing numerous chances to catch a fish. A jug rig commonly consists of some type of a jug, such as a laundry detergent container, milk-jug, or other similar-sized plastic recycled container or floating device, which has tied thereon a length of fishing line, a hook and a sinker. The hook is baited and the sinker keeps the line taught in the water and brings the hook below the surface of the water. The jug is free to float around the body of water. Since the fisherman does not have to hold each line, as is required when using a conventional rod and reel, he or she can set out multiple lines and merely monitor the status of each line. If a catfish or other fish feeds on the bait and subsequently hooks itself, then the jug will move around with the fish as it swims. Typically the jugs that are used have sufficient buoyancy to keep the jug above water while the fish is swimming around in the water. Thus, the fisherman must only find the jugs and check to see if a fish is hooked thereon.

Some avid fishermen feel that jug fishing is not “sporting” and is unfair because the fishermen may set out tens of baited hooks that just float around a lake, pond, river, or other body of water until a fish takes the bait. Other than releasing the jug rigs, the fisherman has no active or strategic role in catching the fish. This negative opinion is furthered when considering that most catfish are nocturnal and, therefore, many jug fishermen put out jugs the previous day and then come back the next morning to find the jugs and any hooked fish in the daylight. Jug-fishing also takes away the sporting fight between the fish and fisherman experienced when using the bait-casting method since when jug fishing, once the fisherman catches up with the fish, it is usually exhausted from dragging around the jug.

Thus, there is a need in the art to provide a cast-able buoyant fishing device that assists a traditional bait-cast fisherman in catching large fish that helps prevent the fish from swimming down to protective cover, back into its cave or any other area where there is a greater chance for the line being nicked or cut and thus breaking under tension. Moreover, there is a need in the art to provide a visual indicator of the position of the fishing line and/or any change in location of the line that is visible at night which may indicate a fish is on the line. Further, there is a need for a low-cost option for converting an existing container into a fishing aid that addresses the above needs.

### SUMMARY OF THE INVENTION

The present invention is directed toward a buoyant fishing device comprising a substantially hollow container body, a rigging ring operably connected to the hollow body, and an illumination device disposed within the hollow body. The hollow body of the buoyant fishing device may include a first end and a second end and the hollow body may further include a lid or cap removably coupled to the hollow body at one end.

The rigging ring of the buoyant fishing device of the present invention may include a securing mechanism. The securing mechanism may be a weld, adhesive, a screw-type clamp closure, a cable-tie-like mechanism, or at least one tab configured to engage one of a plurality of slots in said rigging ring to provide an adjustable circumference of said rigging ring. An embodiment may include the tab being positioned at one end and initially extending outwardly substantially normal to the face of the band and the slots may be located near the opposite end and configured to receive the tab. The rigging ring may also include a connector loop that will receive the line from the rod and reel and also receive the line extending to the bait. The buoyant fishing device may also comprise a first line and a second line wherein the first line leads to a fishing rod and is then operably connected to the rigging ring and the second line may be operably connected to the rigging ring and configured to be connected to a fishing hook, lure, and/or bait.

The illumination device of the buoyant fishing device may also provide a light source within or on the buoyant fishing device so that the buoyant device may be seen while night fishing. Embodiments of illumination device may include a glow stick or a light powered by a battery.

Other aspects and advantages of the present invention will be apparent from the following detailed description of the preferred embodiments and the accompanying drawing figures.

### BRIEF DESCRIPTION OF THE SEVERAL VIEWS OF THE DRAWING

The accompanying drawings form a part of the specification and are to be read in conjunction therewith, in which like reference numerals are employed to indicate like or similar parts in the various views.

FIG. 1 is a front view of one embodiment of the present buoyant fishing device constructed in accordance with the teachings of the present invention;

FIG. 2 is a sectional view of another embodiment of the present illumination device constructed in accordance with the teachings of the present invention;

FIG. 3 is a perspective view of one embodiment of the rigging ring of the present illumination device constructed in accordance with the teachings of the present invention;

FIG. 4 is a perspective view of another embodiment of the rigging ring of the present illumination device constructed in accordance with the teachings of the present invention; and

FIG. 5 is a sectional side view of another embodiment of the rigging ring of the present illumination device constructed in accordance with the teachings of the present invention.

### DETAILED DESCRIPTION OF THE INVENTION

The following detailed description of the present invention references the accompanying drawing figures that illustrate specific embodiments in which the invention can be practiced. The embodiments are intended to describe aspects of the present invention in sufficient detail to enable those skilled in the art to practice the invention. Other embodiments can be utilized and changes can be made without departing from the spirit and scope of the present invention. The present invention is defined by the appended claims and, therefore, the description is not to be taken in a limiting sense and shall not limit the scope of equivalents to which such claims are entitled.

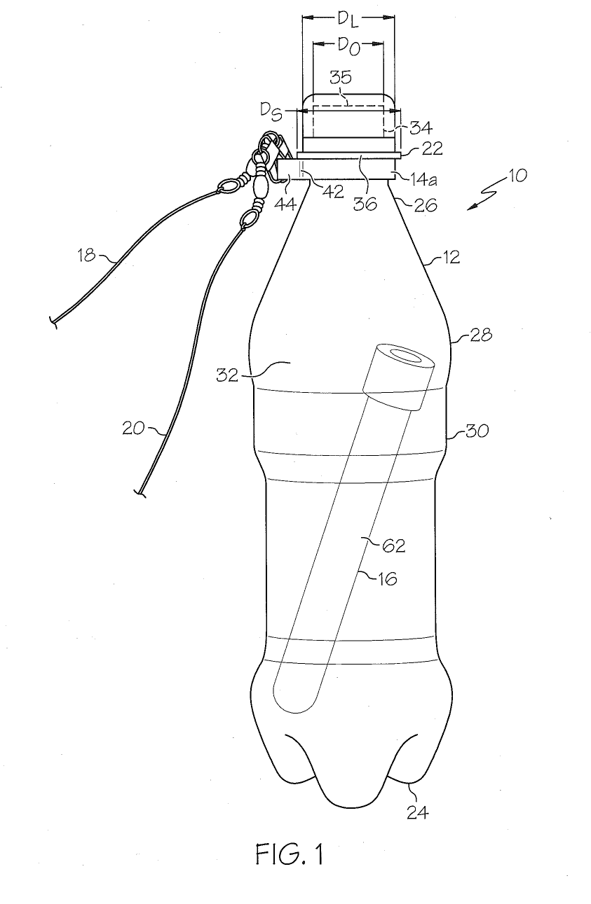

As illustrated in FIG. 1, the present invention is directed toward a buoyant fishing device 10 configured to assist fisherman when fishing during the day or at night. Buoyant fishing device 10 comprises a body 12, a rigging ring 14, and an illumination device 16. Buoyant fishing device 10 may also have a first line 18 and a second line 20 operably connected to rigging ring 14. First line 18 may extend from a fishing rod (not shown) to fishing device 10 and second line 20 may extend from fishing device 10 to a lure (not shown) that may comprise a hook and bait (not shown). Lines 18 and 20 may be coupled to rigging ring 14 using any method or device now known or hereafter developed including tying the line 18 or 20 directly to the rigging ring 14, using a mechanism 21 such as a locking snap, a swivel, a clip, a split ring, or any other method now known or hereafter developed.

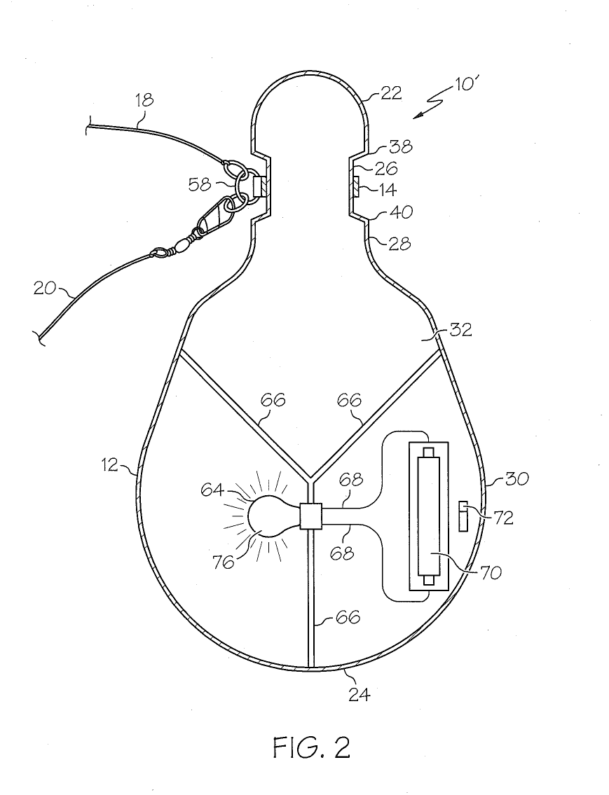

As shown in FIGS. 1 and 2, body 12 includes a first end 22, a second end 24, a neck 26, a shoulder 28, and an outer surface 30 that defines an interior volume 32. One embodiment of body 12 may be substantially hollow. Embodiments of body 12 may be one of many different shapes including, preferably, substantially cylindrical, conical, “tear-drop,” and/or spherical as illustrated in FIGS. 1 and 2, although it is further recognized and anticipated that body 12 take on any shape now known or hereafter developed. Body 12 may be made from molded or extruded polymers, cast, machined, or formed metals, polymer composite-plastics, or any combination thereof, or any other water-proof material now known or hereafter developed. Body 12 is generally made from a water-proof material which resists water from entering the hollow interior volume 32 through outer surface 30.

FIG. 1 shows one embodiment of body 12 which resembles a twenty (20) ounce plastic beverage container. Body 12 may be a re-dedicated beverage container or it may be originally manufactured to have a substantially similar shape. This embodiment includes a lid or cap 34 operably positioned at first end 22 of body 12. Lid or cap 34 is removable and reusable and allows a user to access the inner volume 32 of body 12 through an opening 35. Lid or cap 34 may be a screw-top, a clamping tip, or any other lid or cap configuration now known or hereafter developed which seals opening 35 and creates a substantially water-proof body 12. Lid or cap 34 has a diameter D_{L} that is larger than the diameter D_{O} of opening 35. This embodiment further includes a ring stop 36 below lid or cap 34 that extends outwardly from body 12. One embodiment of the present fishing device includes ring stop 36 having a diameter D_{S} that is larger than diameter D_{L} of lid or cap 34.

FIG. 2 shows another embodiment of the present fishing device 10′ wherein body 12 includes an exterior surface 30 which is in a tear-drop or other similar shape. In this embodiment, body 12 further includes a top ring stop 38 proximate one end of neck 26 and a bottom ring stop 40 opposing top ring stop 38.

As shown in FIGS. 1 and 2, rigging ring 14 is secured and positioned on body 12 proximate neck 26. Rigging ring may be coupled to body 12, or may be secured about body 12 wherein rigging ring 14 may slide around the perimeter and/or along the length of neck 26 of body 12. Rigging ring 14 includes a width and a thickness that can be varied to provide greater ultimate load capacity or deflection resistance. Rigging ring 14 may be made from metal, polymer, plastic, polymer composite, or any combination thereof and constructed using any manufacturing method now known or hereafter developed in the applicable art.

Rigging ring 14 is secured about body 12 in any method now known or hereafter developed. The embodiment shown in FIG. 1 includes rigging ring 14a initially being a circular ring having an interior diameter larger than the diameter D_{S} of ring stop 36. This rigging ring 14a is slipped over lid or cap 34 and ring stop 36 wherein a user uses a tool to form a crimp 42 thus forming two substantially distinct sections of the rigging ring: one around neck 26 and a stand-alone loop 44.

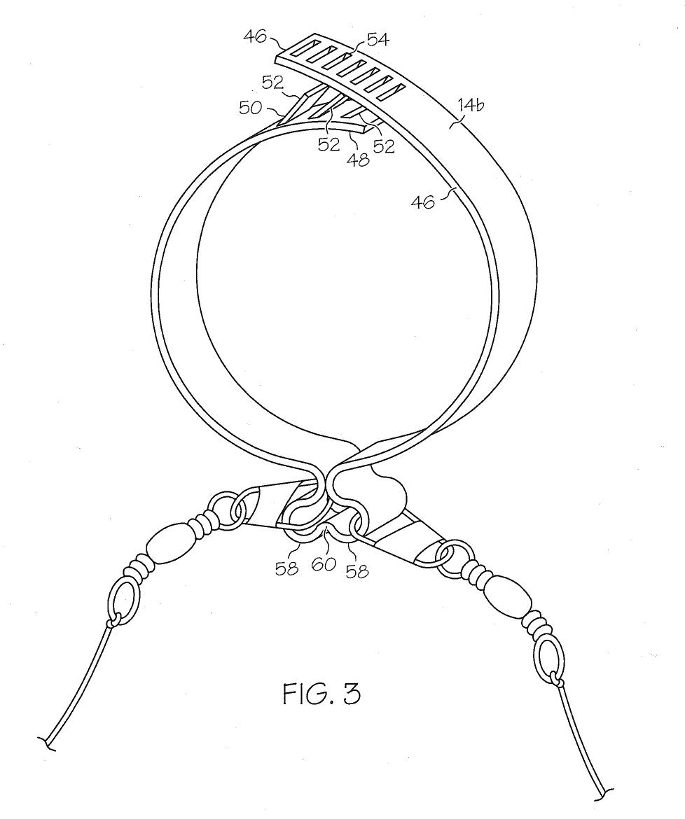

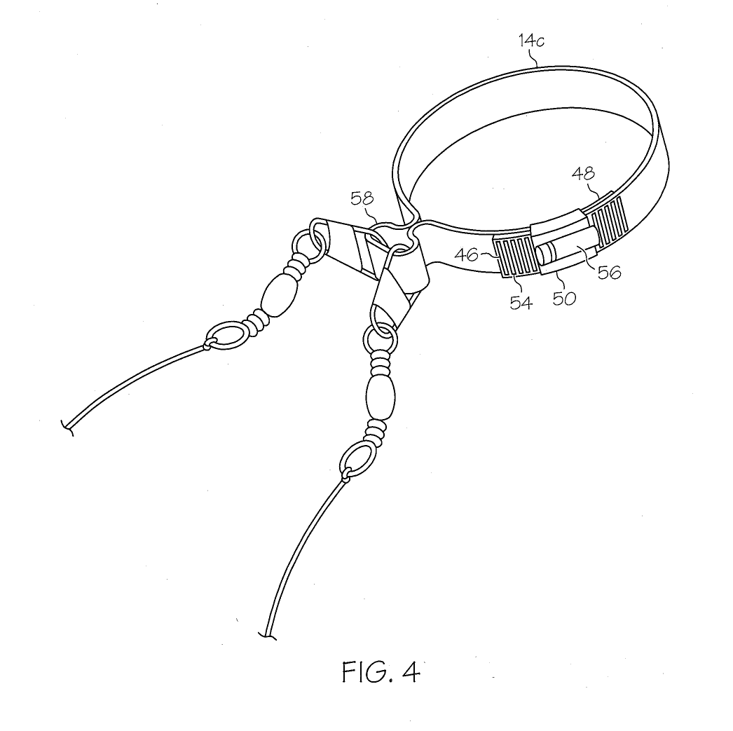

Alternative embodiments of rigging ring 14 are shown in FIGS. 3 and 4. In these embodiments rigging ring 14b (FIG. 3) and 14c (FIG. 4) have a first free end 46 and a second free end 48 and extends around the body 12 or a feature of body 12 circumferentially. An adjustable securing mechanism 50 is disposed on second free end 48. Rigging ring 14b includes securing mechanism 50 being one or more tabs 52 that may be initially disposed at an angle toward second free end 48 as shown wherein a portion of first end 46 includes a series of slots 54 spaced to match the spacing of tabs 52 as shown. A user would tighten rigging ring 14b around neck 26, insert tabs 52 through slots 54 and bend tabs 52 back over and away from second end 48 to secure rigging ring 14b in a position as shown.

Another embodiment of the rigging ring 14c is shown in FIG. 4 wherein securing mechanism 50 is a screw-type clamp closure 56 coupled to rigging ring 14c proximate the second free end 48. Again, first free end 46 includes a plurality of spaced slots 54 and when first free end 46 is inserted into screw-type clamp closure 56, the slots 54 align with a plurality of external threads (not shown) associated with the screw-type clamp closure 56. A user may continue to tighten the closure 56 until rigging ring 14c is tight about the perimeter of neck 26. Other embodiments of rigging ring 14 and securing mechanism 50 are also within the scope of the present invention. For example, securing mechanism 50 could be a fastener such as a rivet, adhesive, bolt, chemical weld, weld, zip-tie, or any other such method to fix first free end 46 with respect to second free end 48, either permanently or temporarily. Alternatively, rigging ring 14 may be a wire or other similar configuration that performs the same function.

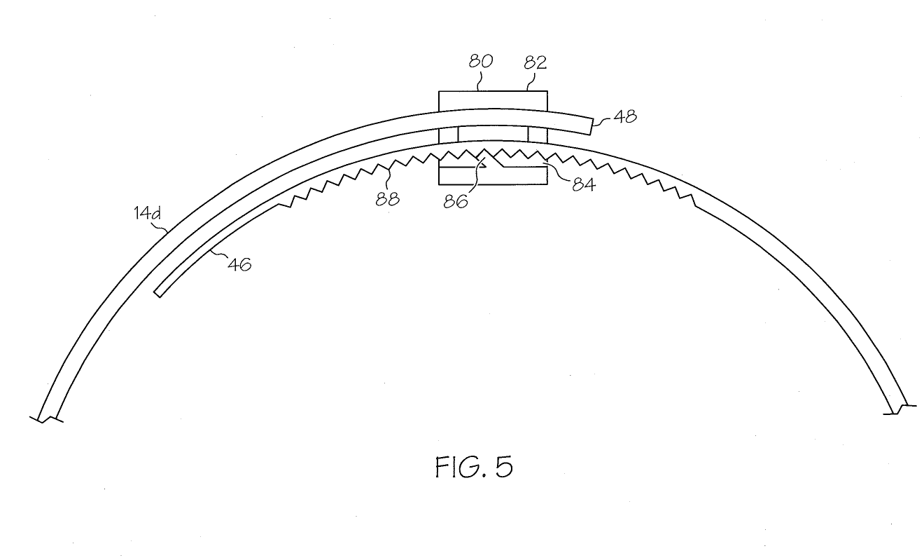

FIG. 5 illustrates another embodiment of rigging ring 14d including a securing mechanism 50 comprising a cable-tie-like mechanism 80. As shown, cable-tie-like mechanism 80 is disposed on second free end 48. Cable-tie-like mechanism 80 includes a guide housing 82 that includes a slot 84 which receives first free end 46 and a flexible arm 86 angled in the desired direction of movement of first end 46 that results in tightening the loop formed by rigging ring 14d. A portion of first free end 46 includes a plurality of triangular shaped teeth 88 which are disposed on one face of the first free end 46 as shown. As first free end is inserted into slot 84 and pushed through cable-tie mechanism 80, arm 86 flexes up as one side of side of angled tooth 88 is pulled through and then drops to engage the other side of tooth 88 that is substantially perpendicular to arm 86. This configuration allows the first free end 46 to be pulled relative to cable-tie-like mechanism 80 to decrease the diameter of rigging ring 14d, but arm 86 engages tooth 88 as shown and does not allow the first free end 46 to be displaced in the opposite direction, which acts to secure rigging ring 14d around body 12.

As shown in FIGS. 1-4, rigging ring 14, 14 a-c also include a connector loop 58. Connector loop 58 may be integral with or coupled to rigging ring 14 and provides the structure that first line 18 and second line 20 may be coupled to fishing device 10. Connector loop 58 may be fixed to rigging ring 14a as shown in FIG. 1, or may be otherwise operably connected to rigging ring 14 as shown in FIG. 2. As shown if FIG. 3, one embodiment of loop connector 58 of rigging ring 14 includes a crimp 60. Crimp 60 may be beneficial in that it (1) helps strengthen the loop by making it resistant to bending, and/or (2) it divides the loop into sections so that first line 18 and second line 20 may be coupled its own portion of loop connector 58. Crimp 60 may be an indentation in the surface of a portion of connector loop 58 forming a nob, or an indentation of the entire loop 58.

FIGS. 1 and 2 also illustrate alternative embodiments of illumination device 16. Illumination device 16 allows a fisherman to view the present fishing device 10 and 10′ at night when it is in the water. Because some fishing is done a night, particularly for catfish, illumination device 16 helps fishermen locate and see movement of the present fishing device 10 and 10′. FIG. 1 illustrates one embodiment of illumination device 16 being a glow stick 62 that currently has wide commercial availability. Glow stick 62 is a disposable light source that, once activated, provides a glow of light for a predetermined amount of time. Glow stick 62 can be inserted and removed from body 12 of present fishing device 10 by removing lid or cap 34. The embodiment illustrated in FIG. 1 is not be limited to glow stick 62 as any form of disposable light source now known or hereafter developed is within the scope of the present invention.

Another embodiment of illumination device 16 is illustrated in FIG. 2. The present fishing device 10′ includes a light 64 fixed within body 12 using one or more supports 66. Because light 64 is fixed within body 12, this embodiment may include wiring 68 connecting light 64 to at least one battery 70. Further, the operation of light 64 may be controlled by switch 72 that is in electronic communication with light 64 and at least one battery 70. This embodiment is beneficial in that the light may be used multiple times, simply by replacing the batteries 70 or the light bulb 64 when they burn out. This makes the present fishing device 10′ self-contained with no additional parts and also frees up the fishermen from having to buy and carry replacement glow sticks 62. Light 64 may be a common, replaceable bulb type now known or hereafter developed. Further, battery 70 may be housed within a battery housing 74 formed into outer surface 30 of body 12 and may be covered with a water-proof cover having a seal disposed around the perimeter of battery housing 74 to keep the battery housing water-proof. Any method of sealing battery housing now known or hereafter developed is within the scope of the present invention. One embodiment includes light 64 being removable through housing 74. Moreover, any other conventional means of accessing the light 64 and/or the battery 70 is within the scope of the present invention.

In use, fishing device 10 or 10′ may be used with any rod and reel combination, such as bait cast, spinning, fly, or any other known rod and reel type. In one embodiment, a user will operably connect rigging ring 14 to a repurposed empty plastic beverage or like container by securing rigging ring 14 around neck 26 of body 12 using securing mechanism 50. The re-purposed soda, water, or other beverage containers commonly have volumes of about twenty ounces, although other common container sizes such as twelve ounces, sixteen ounces, one-liter, two-liter, half-gallon, or gallon may also be used so long as the container body 12 has sufficient volume to remain substantially buoyant. The foregoing are examples of commonly sized containers and it is recognized and anticipated that any container volume between about twelve ounces and about one gallon may be incorporated into the present invention. A fisherman will connect an end of the first fishing line 18 coming from the reel to rigging ring 14 of present fishing device 10 or 10′. The user will connect an end of a second line 20 of fishing line to rigging ring 14 and then the other end to the lure or other bait. The length of second line 20 may be any length desired by the fisherman depending upon the depth of water being fished or other considerations. A user may tie additional weights or bottom-bouncing devices onto second line 20 between the lure and/or bait and fishing device 10 or 10′. Any lure and/or bait known in the art may be used with the present fishing device 10 or 10′. This may include a hook having live and/or artificial bait disposed thereon, and/or artificial lures of any type. Artificial lures may also include hooks that may or may not include having live and/or artificial bait disposed thereon

If the fisherman is fishing at night, he or she may then activate illumination device 16 so that fishing device 10 or 10′ is illuminated. The fisherman may then cast fishing device 10 or 10′ and second line 20 out into the water. Second line 20 drops below the surface of the water with the lure. Volume 32 of fishing device 10 is such that it provides enough buoyancy to substantially offset the weight of the lure and any extra sinkers or weights attached to second line 20.

If all goes well, a fish will ingest the lure and/or bait and one or more hooks associated therewith will catch the fish's mouth or otherwise catch the fish. When the fish begins swimming with the hook in its mouth or otherwise caught, fishing device 10 or 10′ will either move on the surface of the water, or it will be slightly pulled under the surface of the water. The fisherman may then apply pressure to the fish to set the hook either by raising or moving the rod or by reeling in the line using a reel. Often, fish only realize they are hooked when this pressure is applied. Some fish, particularly catfish, attempt to swim down into a hole, void, shelf or other protective structure underwater upon sensing being hooked. The volume 32 of fishing device 10 or 10′ may also provide upward buoyancy to resist the fish swimming downward and reaching a cave, hole, or other protective structure. Keeping the fish from reaching the rocky bottom or protective structures helps to ensure that second line 20 is not nicked or cut by rocks or other shoreline or bottom structures.

Volume 32 of fishing device 10 or 10′ also provides drag on the surface of the water that assists the fisherman in fighting and landing a fish successfully. The combination of features of the present fishing device 10 or 10′ provides many unexpected benefits. Present buoyant fishing device 10 or 10′ combines the benefits associated with jug fishing in a cast-able embodiment. Thus, it is used with a conventional rod and reel, and therefore can likely be used legally in any of the fifty states. Further, embodiments of the buoyant fishing device of the present invention allow the user to locate and view device 10 or 10′ when it is dark. Finally, embodiments of rigging ring 14 allow a user to recycle a used container into a functional buoyant fishing device.

As is evident from the foregoing description, certain aspects of the present invention are not limited to the particular details of the examples illustrated herein. It is therefore contemplated that other modifications and applications using other similar or related features or techniques will occur to those skilled in the art. It is accordingly intended that all such modifications, variations, and other uses and applications which do not depart from the spirit and scope of the present invention are deemed to be covered by the present invention.

Other aspects, objects, and advantages of the present invention can be obtained from a study of the drawings, the disclosures, and the appended claims.

I claim:

1. A buoyant fishing device comprising:
a substantially hollow body;
a rigging ring operably connected to said body; and
an illumination device disposed within said body.

2. The buoyant fishing device of claim 1 wherein said substantially hollow body includes a first end and a second end and said body further includes a lid removably coupled to said body proximate said first end.

3. The buoyant fishing device of claim 1 wherein said rigging ring further comprises a securing mechanism.

4. The buoyant fishing device of claim 3 wherein the securing mechanism is a screw-type clamp closure.

5. The buoyant fishing device of claim 3 wherein the securing mechanism is a least one tab configured to engage one of a plurality of slots in said rigging ring to provide an adjustable circumference of said rigging ring.

6. The buoyant fishing device of claim 1 wherein said rigging ring further includes a connector loop.

7. The buoyant fishing device of claim 6 wherein said connector loop includes a crimp.

8. The buoyant fishing device of claim 1 wherein said illumination device is a glow stick.

9. The buoyant fishing device of claim 1 wherein said illumination device is a light in electronic communication with a battery.

10. The buoyant fishing device of claim 9 wherein said battery is housed within a water-proof housing.

11. The buoyant fishing device of claim 1 further comprising a first line and a second line, said first line leading to a fishing rod and operably connected to said rigging ring and said second line operably connected to said rigging ring and configured to be connected to a fishing hook.

12. A buoyant fishing device comprising:
a substantially hollow body having a neck, a first end and a second end;
a rigging ring operably connected to said neck, said rigging ring including a securing mechanism and a connector loop; and
an illumination device disposed within said body wherein said illumination device is configured to illuminate said buoyant fishing device.

13. The buoyant fishing device of claim 12 wherein said rigging ring includes a first end and a second end, said first end having a plurality of slots disposed therein.

14. The buoyant fishing device of claim 13 wherein said rigging ring includes at least one tab disposed on said second end of said rigging ring wherein said at least one tab is configured to engage one of said slots to secure said rigging ring in a loop.

15. The buoyant fishing device of claim 13 wherein said rigging ring includes a screw-type clamp closure disposed on said second end of said rigging ring wherein said screw-type clamp closure is configured to engage one of said slots to secure said rigging ring in a loop.

16. The buoyant fishing device of claim 12 wherein said rigging ring is secured to said neck by crimping said rigging ring to form two distinct loops wherein one loop is said connector loop.

17. The buoyant fishing device of claim 12 wherein said illumination device is a glow stick.

18. The buoyant fishing device of claim 12 wherein said illumination device is a light in electronic communication with a battery.

19. The buoyant fishing device of claim 18 wherein said light may be selectively turned off and on with a switch.

20. The buoyant fishing device of claim 12 wherein said rigging ring includes a first end and a second end, said first end having a triangular teeth disposed thereon, and wherein said second end includes a securing mechanism comprising a cable-tie-like mechanism having a housing that receives said first end and an arm that engages at least one of a plurality of said teeth.

21. A rigging ring for converting a container into a buoyant fishing device comprising:
a band having a first end and a second end defining a length, said band configured to extend around a container circumferentially;
a first end having a plurality of slots through said band, said slots being transverse to said length and uniformly spaced along a portion of the length of said band proximate said first end;
a securing mechanism disposed on said second end and configured to engage one or more of said plurality of slots to fix the first end with respect to the second end by engaging said slots; and
a connector loop disposed on said band between said first and said second end.

22. The rigging ring of claim 21 wherein said securing mechanism includes at least one tab wherein said at least one tab is configured to pass through one of said slots and fold over to secure said rigging ring to a container.

23. The rigging ring of claim 21 wherein said rigging ring includes a screw-type clamp closure disposed on said second end of said band wherein said screw-type clamp closure is configured to engage one of said slots to secure said rigging ring to a container.
